(19) United States
(12) Patent Application Publication
(10) Pub. No.: US 2025/0095943 A1
(43) Pub. Date: Mar. 20, 2025

(54) FUSE AND ITS PREPARATION PROCESS

(71) Applicant: Taicang Manaflex Technology Co., Ltd., Taicang City (CN)

(72) Inventors: Robert C. Lane, Las Vegas, NV (US); Augusto E. Barton, Pinecrest, FL (US); Fujiang Li, Kunshan City (CN)

(21) Appl. No.: 18/883,175

(22) Filed: Sep. 12, 2024

(30) Foreign Application Priority Data
Sep. 15, 2023 (CN) 202311196304.5

(51) Int. Cl. H01H 85/08

(52) U.S. Cl. CPC H01H 85/08; H01H 2209/018; H01H 2209/026; H01H 2229/02

(57) ABSTRACT

A production process for sintering a nickel layer on an aluminum sheet, and to prepare an aluminum sheet with a nickel layer, which can be directly used for tinning and soldering. A fuse that has a sheet-shaped fuse body, the width of the fuse body does not exceed 2 mm, and the thickness of the fuse body does not exceed 0.2 mm. The fuse has a plurality of adjustment holes and/or adjustment grooves are provided in the fuse body. In one embodiment, the fuse body and the corresponding external circuit are integrally formed. In the fuse, welding platforms are protruded at both ends of the fuse body, respectively, and the width of the welding platform is greater than the width of the fuse body.

### CROSS-REFERENCE TO RELATED APPLICATION

This application claims priority to and the benefit of Chinese Utility Model application No. 202311196304.5, filed Sep. 15, 2023, the entire disclosure of which is incorporated by reference in its entirety.

### TECHNICAL FIELD

The present invention relates to the field of vehicle power supply safety technology, and in particular to a fuse and its preparation process.

### BACKGROUND

A flexible printed circuit (FPC) conductor in a traditional vehicle power management system is made of metal copper, which is mostly processed by mechanical stamping and die cutting. For cost and other considerations, metal aluminum has gradually replaced metal copper. In a power management system of a power battery, the status monitoring of each battery cell is a very critical link, which is related to the safety of the entire battery pack and even the vehicle. The aluminum fuse in the voltage acquisition circuit in the FPC is a key part to ensure the safety performance of the circuit; when the circuit current is too large, the fuse needs to be blown within a specified time to ensure the safety of the entire circuit, so the fuse must have a certain resistance value and a time limit for blowing under a certain current; but the structure of the aluminum fuse and the processing scheme have no relevant technology in the industry.

### SUMMARY

In order to overcome the above shortcomings, the purpose of the present invention is to provide a production process for sintering a nickel layer on an aluminum sheet, and to prepare an aluminum sheet with a nickel layer, which can be directly used for tinning and soldering.

In order to achieve the above purpose, the technical solution adopted by the present invention is:

A fuse, characterized in that it includes a sheet-shaped fuse body, the width of the fuse body does not exceed 2 mm, and the thickness of the fuse body does not exceed 0.2 mm.

Furthermore, in the above-mentioned fuse, a plurality of adjustment holes and/or adjustment grooves are provided in the fuse body.

Furthermore, in the above-mentioned fuse, the fuse body and the corresponding external circuit are integrally formed.

Further, in the above-mentioned fuse, welding platforms are protruded at both ends of the fuse body, respectively, and the width of the welding platform is greater than the width of the fuse body.

Further, in the above-mentioned fuse, the welding platform is integrally formed with the fuse body.

The present invention also discloses a preparation process of a fuse, which is used to prepare the above-mentioned fuse, including the following steps:
S1, contour cutting: cutting the aluminum foil into a circuit by optical fiber laser, and forming a fuse body at the corresponding position, or cutting the aluminum foil into a fuse body by optical fiber laser;
S2, finishing cutting: using a nanosecond ultraviolet laser to process the width and thickness of the fuse body;
S3, resistance adjustment processing: using a nanosecond ultraviolet laser to process a number of adjustment holes and/or adjustment grooves in the fuse body.

Further, in the preparation process of the above-mentioned fuse, the power of the nanosecond ultraviolet laser is 20 W, the frequency is 60 KHZ, the wavelength is 355 nm, the single pulse energy is 0.33 mj and the pulse period is less than 15 ns.

Further, in the preparation process of the above-mentioned fuse, the adjustment hole is a through-hole structure.

Further, in the preparation process of the above-mentioned fuse, the adjustment groove runs through the fuse body and is arranged along the length and/or width direction of the fuse body.

Further, in the preparation process of the above-mentioned fuse, the adjustment groove is distributed in a zigzag shape.

The beneficial effects of the present invention include:

The fuse of the present invention has a simple structure. By precisely machining the fuse body and machining the adjustment hole and/or adjustment slot, the resistance of the fuse is changed, which makes the design of the fuse more flexible and provides great convenience for the design and processing of the fuse in the aluminum conductor FPC, meets the demand for low current fusing in the vehicle power management system, and improves the safety of the circuit.

### BRIEF DESCRIPTION OF THE FIGURES

In order to more clearly illustrate the technical solutions in the embodiments disclosed herein, the drawings are briefly introduced below. Obviously, the drawings described below are only some embodiments disclosed herein. For ordinary technicians in this field, other drawings can be obtained based on these drawings without creative work.

FIG. 1 shows a structural schematic diagram of a fuse with an adjustment hole and an adjustment slot in the specific embodiment of the present invention.

FIG. 2 shows a structural schematic diagram of a fuse with an adjustment hole in another specific embodiment of the present invention.

FIG. 3 shows a structural schematic diagram of a fuse with an adjustment slot in another specific embodiment of the present invention.

FIG. 4 shows a structural schematic diagram of a fuse in another specific embodiment of the present invention.

FIG. 5 shows a structural schematic diagram of a fuse in another specific embodiment of the present invention.

FIG. 6 shows a structural schematic diagram of a fuse in another specific embodiment of the present invention.

FIG. 7 shows a structural schematic diagram of a fuse in another specific embodiment of the present invention.

FIG. 8 shows a structural schematic diagram of a fuse in another specific embodiment of the present invention.

FIG. 9 is a schematic diagram of the structure of the fuse in a seventh embodiment of the present invention.

FIG. 10 is a schematic diagram of the structure of the fuse in an eighth embodiment of the present invention.

FIG. 11 is a schematic diagram of the structure of the fuse in a ninth embodiment of the present invention.

FIG. 12 is a schematic diagram of the structure of the fuse in a tenth embodiment of the present invention.

FIG. 13 is a schematic diagram of the structure of the fuse in an eleventh embodiment of the present invention.

FIG. 14 is a schematic diagram of the structure of the fuse in a twelfth embodiment of the present invention.

### DESCRIPTION

The technical scheme in the embodiment of the present invention is described in detail below in conjunction with the accompanying drawings in the embodiment of the present invention.

It is obvious that the described embodiments are only part of the embodiments of the present invention, not all of them. Based on the embodiments of the present invention, all other embodiments obtained by ordinary technicians in this field without creative work are within the scope of protection of the present invention.

### Embodiment 1

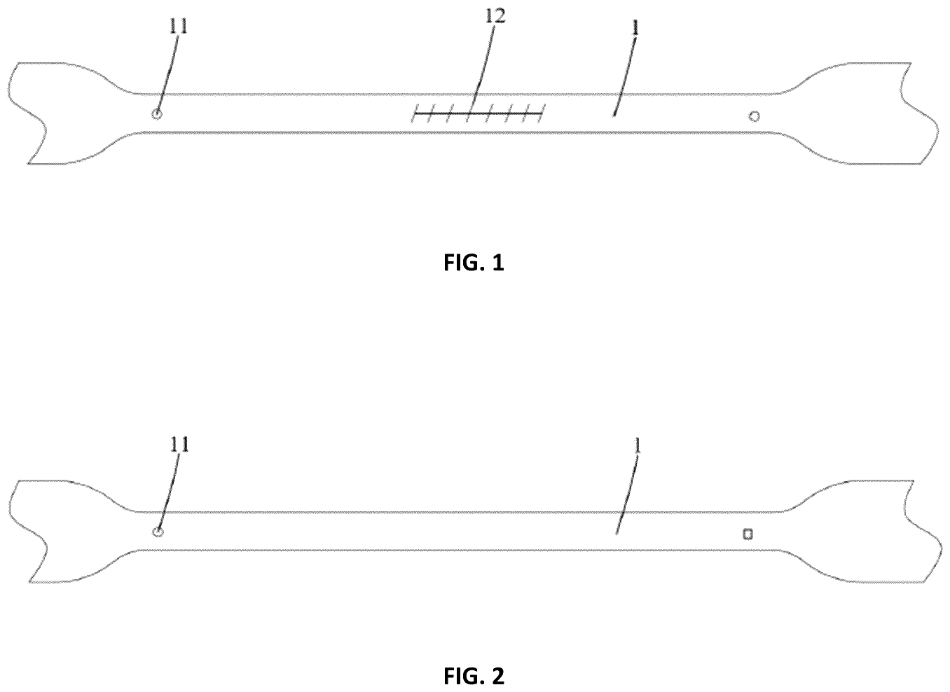

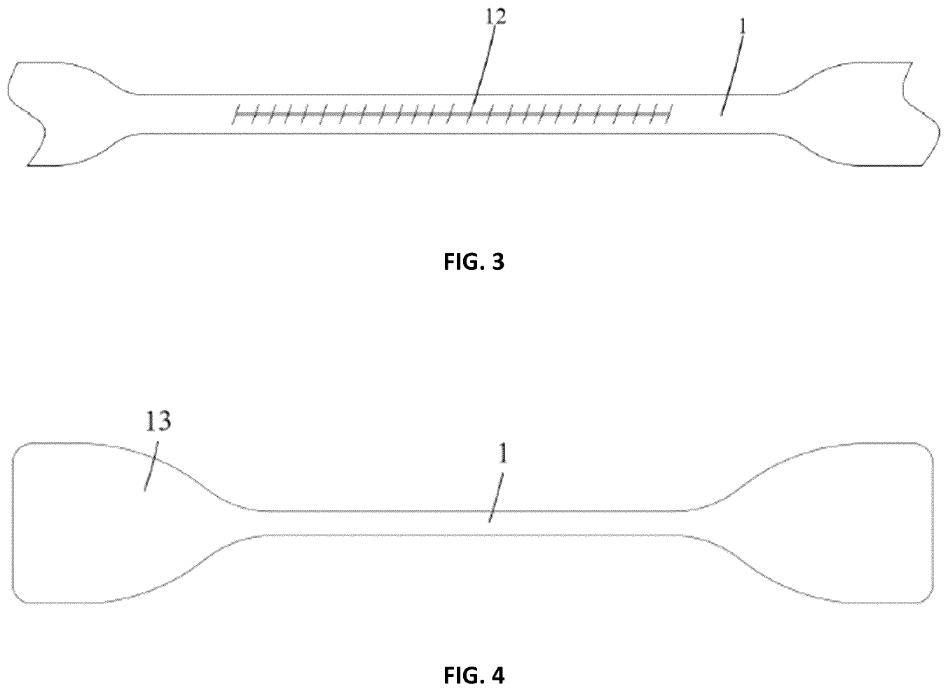

As shown in FIGS. 1 to 9, a fuse includes a sheet-shaped fuse body 1, which is made of metal aluminum, and the width of the fuse body does not exceed 2 mm, and the thickness of the fuse body does not exceed 0.2 mm.

In this technical solution, for compact design, the fuse length is limited, and the resistance of the fuse R=ρL/S, that is, the resistance R of the fuse is proportional to its length L and resistivity ρ, and inversely proportional to its cross-sectional area S. The fuse width and thickness can be reduced to reduce its cross-sectional area, thereby shortening the fuse length, without occupying a large space, meeting the overall compactness of the battery pack, and at the same time meeting the requirements of low current fusing, solving the technical problem that the existing circuit cannot make a low current fusing fuse due to material properties and thickness limitations, that is, solving the technical problem that the fusing current of the existing circuit fuse is not low enough. The fuse structure of the present invention is simple, and the resistance of the fuse is changed by precision machining of the fuse body and machining of adjustment holes and/or adjustment slots, which makes the design of the fuse more flexible and free, providing great convenience for the design and processing of fuses in aluminum conductor FPCs, meeting the requirements of low current fusing in vehicle power management systems, and improving the safety of circuits.

For example, referring to FIGS. 1-3, a plurality of adjustment holes 11 and/or adjustment slots 12 are provided in the fuse body 1.

In this technical solution, in order to ensure the strength of the fuse and avoid breaking due to shaking and the like, the fuse body needs to have a certain width and thickness. When its length is determined, by machining adjustment holes and/or adjustment slots in the fuse body, the resistance of the fuse is changed, which makes the design of the fuse more flexible and provides great convenience for the design and processing of fuses in aluminum conductor FPCs, meets the requirements of low current fusing in vehicle power management systems, and improves the safety of the circuit.

For example, as shown in FIGS. 1-3, the fuse body 1 is integrally formed with the corresponding external circuit.

In this technical solution, during the processing of the FPC inner conductor corresponding to the vehicle power management system, the two parts connected by the fuse do not need to be cut off, and the position of the fuse is refined, and its thickness and width are processed to the thickness and width required by the fuse body, and then the adjustment hole and/or adjustment groove are etched in the fuse body to adjust the resistance value of the fuse body to meet the requirements of low current fusing.

For example, as shown in FIG. 4, welding platforms 13 are protruded from both ends of the fuse body, and the width of the welding platform 13 is greater than the width of the fuse body.

In this technical solution, the fuse body is processed independently of the conductor inside the FPC, and there is no need to consider the material and thickness of the conductor inside the FPC, which reduces the difficulty of the production process, improves the product yield, reduces material waste, and reduces production costs. Correspondingly, the material selection of the conductor inside the FPC does not need to consider the need for processing the fuse; after the fuse is processed, the aluminum fuse is directly welded to the aluminum conductor inside the FPC through laser welding to achieve line connection, and it can also fuse when the current is too large to protect the on-board power management system; the welding table ensures that the fuse and the conductor inside the FPC are fully in contact to ensure the welding effect; in addition, the fuse and the conductor inside the FPC can also be made of different materials, and a nickel-plated layer or a nickel-plated aluminum sheet can be added to the welding surface.

### Embodiment 2

A production process of sintered nickel layer of aluminum sheet, comprising the following steps:
S1, contour cutting: cutting aluminum foil into circuits by optical fiber laser, and forming fuse body at corresponding position, or cutting aluminum foil into fuse body by optical fiber laser;
S2, finishing cutting: using nanosecond ultraviolet laser to process the width and thickness of fuse body; and
S3, resistance adjustment processing: using a nanosecond ultraviolet laser to process a number of adjustment holes and/or adjustment grooves in the fuse body.

As shown in FIGS. 4 to 9, for easy handling and measurement, fuses with welding platforms at both ends are cut directly from the aluminum foil. The fuse body is 10 mm long, 2 mm wide, and 0.1 mm thick, and the twelve fuses are numbered from No. 1 to No. 12; using the existing test method and instrument, the resistance value of the fuse body in the No. 1 fuse is measured to be 1.6 mΩ.

### Example 3

As shown in FIG. 5, a 5 mm long and 1.6 mm wide rectangular groove is processed in the fuse body of the No. 2 fuse using a nanosecond ultraviolet laser. The power of the nanosecond ultraviolet laser is 20 W, the frequency is 60 KHZ, the wavelength is 355 nm, the single pulse energy is 0.33 mj, and the pulse period is less than 15 ns. The rectangular groove can also be regarded as a number of holes of various shapes such as rectangles or squares arranged continuously. Using the same test method and instrument as in Example 2, the resistance value of the fuse body in the No. 2 fuse after processing is measured to be 2.48 mΩ. Although the resistance value of the fuse body is increased, the strength of the fuse body is weakened, it is easy to break, etc., and fragments will be generated during the cutting process.

### Example 4

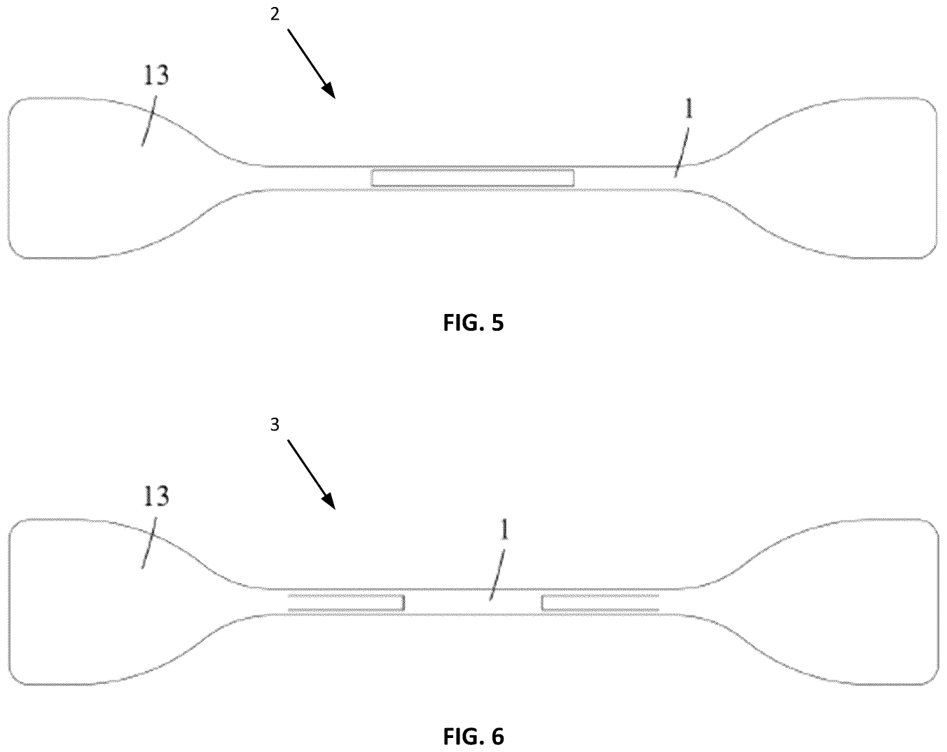

As shown in FIG. 6, two symmetrically arranged “]”-shaped grooves are processed in the fuse body of the No. 3 fuse, with a groove width of 0.1 mm, a groove length along the width direction of the fuse body of 1 mm, and the lengths of the two grooves along the length direction of the fuse body are 3.3 mm respectively. Using the same test method and instrument as in Example 2, the resistance value of the fuse body in the No. 3 fuse after processing is measured to be 2.97 mΩ.

### Example 5

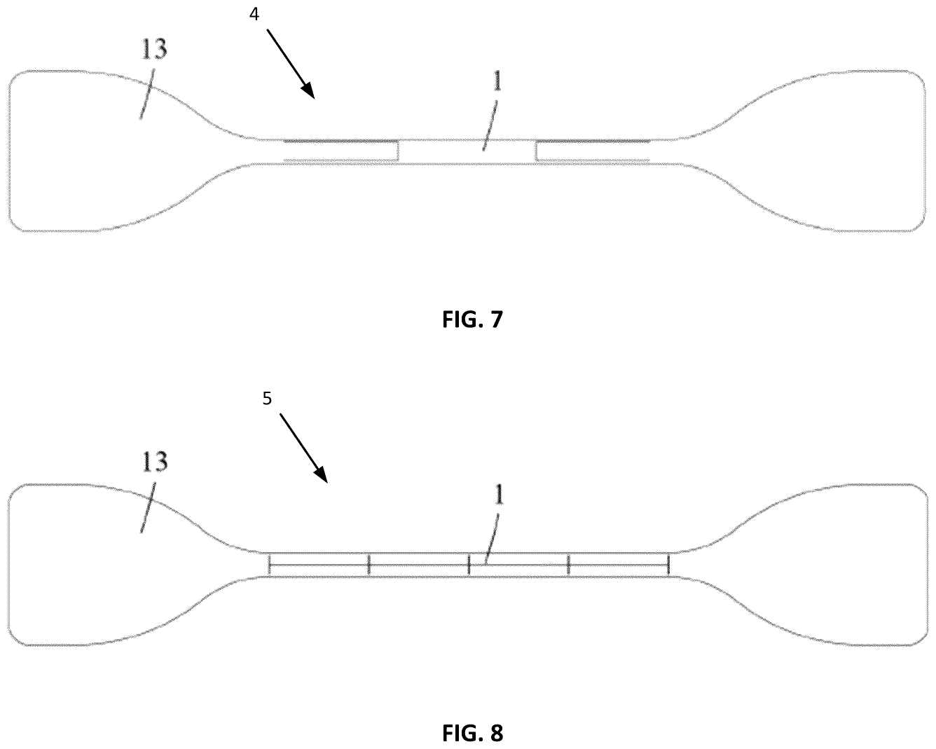

As shown in FIG. 7, two symmetrically arranged “]”-shaped grooves are processed in the fuse body of the No. 4 fuse, with a groove width of 0.1 mm, a groove length along the width direction of the fuse body of 1.8 mm, and the lengths of the two grooves along the length direction of the fuse body are 3.3 mm respectively. Using the same test method and instrument as in Example 2, the resistance value of the fuse body in the No. 4 fuse after processing is measured to be 5.8 m Ω.

Through the analysis of the fourth and fifth embodiments, it can be seen that the thin groove with a processing width of only 0.1 mm can also increase the resistance of the fuse body, and the longer the groove is set along the width direction, the greater the resistance of the fuse body. The strength of the fuse body is also weakened, but compared with the third embodiment, the strength of the fuse body is improved.

### Example 6

As shown in FIG. 8, a horizontal groove arranged along the length direction and four vertical grooves arranged along the width direction are processed in the fuse body of the No. 5 fuse. The vertical grooves are spaced at equal intervals. The horizontal groove runs through the four vertical grooves. The length of the long groove is 10 mm and the width is 0.1 mm. The length of the vertical groove is 1.7 mm and the width is 0.1 mm. The resistance of the fuse body in the No. 5 fuse after processing is measured using the same test method and instrument as in Example 2. The value is 2.63 mΩ.

### Example 7

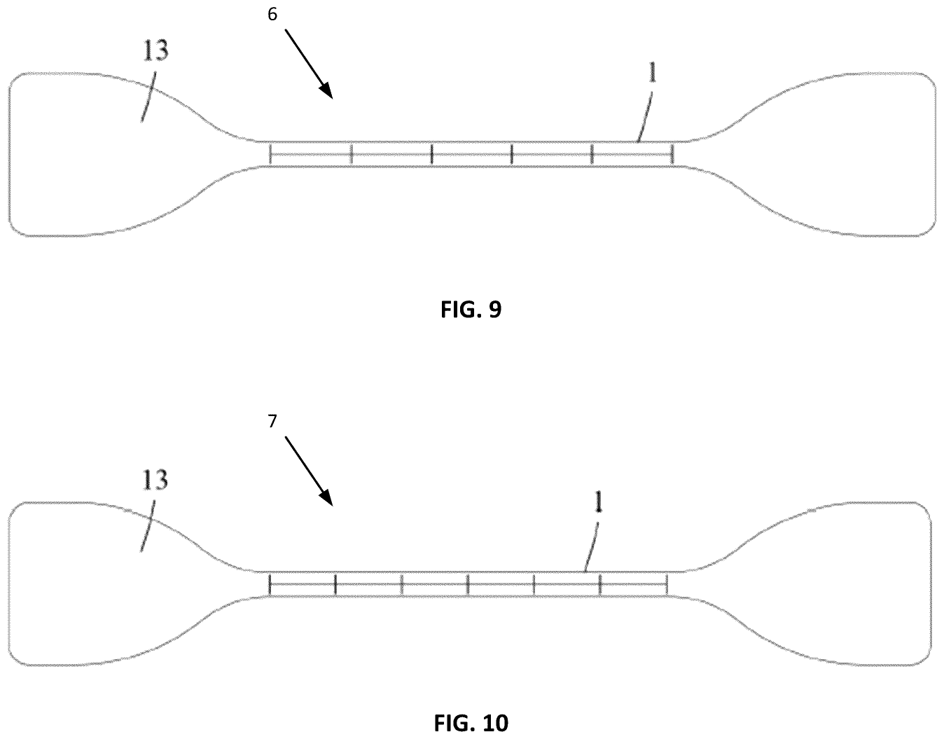

As shown in FIG. 9, the difference from Example 6 is that the number of vertical grooves is six. The same test method and instrument as in Example 2 are used to measure the resistance of the fuse body in the No. 6 fuse after processing. The value is 3.1 mΩ.

### Example 8

As shown in FIG. 10, the difference from Example 6 is that the number of vertical grooves is seven. The same test method and instrument as in Example 2 are used to measure the resistance of the fuse body in the No. 7 fuse after processing. The value is 3.35 mΩ.

Through the analysis of Examples 6 to 8, it can be seen that as the number of vertical grooves increases, the resistance of the resistance wire body increases, and the width of the vertical grooves and the horizontal grooves is only 0.1 mm, and no sheet waste will be generated during the processing.

### Example 9

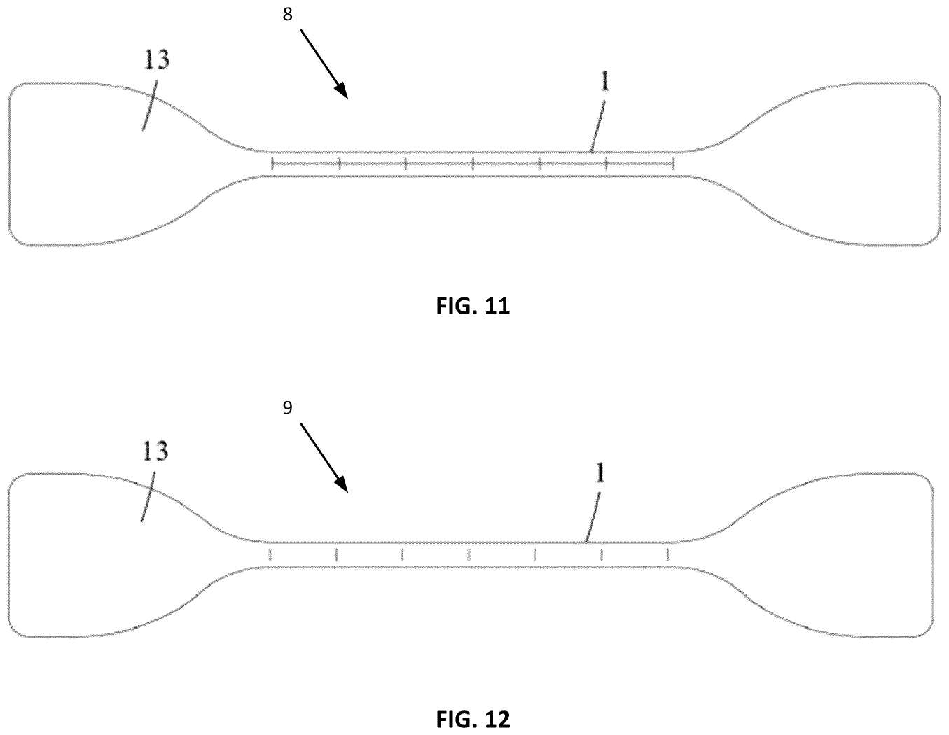

As shown in FIG. 11, unlike Example 8, the length of the vertical groove is 1.5 mm. Using the same test method and instrument as Example 2, the resistance value of the fuse body in the processed No. 8 fuse is measured to be 2.6 mΩ.

### Example 10

As shown in FIG. 12, the difference from the eighth embodiment is that only seven 1.5 mm long vertical grooves are processed. The horizontal groove is cut into two grooves, and the resistance value of the fuse body in the No. 9 fuse after processing is measured using the same test method and instrument as in Example 2, and is 2.5 mΩ.

Through the analysis of Example 8 to Example 10, it can be seen that the resistance value of the fuse body decreases with the shortening of the vertical groove. The horizontal groove has a small effect on the resistance value of the fuse body and can be ignored. However, during the processing of the vertical grooves set at intervals, the nanosecond ultraviolet laser needs to be frequently started and stopped, and the delay caused by repositioning is not conducive to the improvement of processing efficiency.

### Example 11

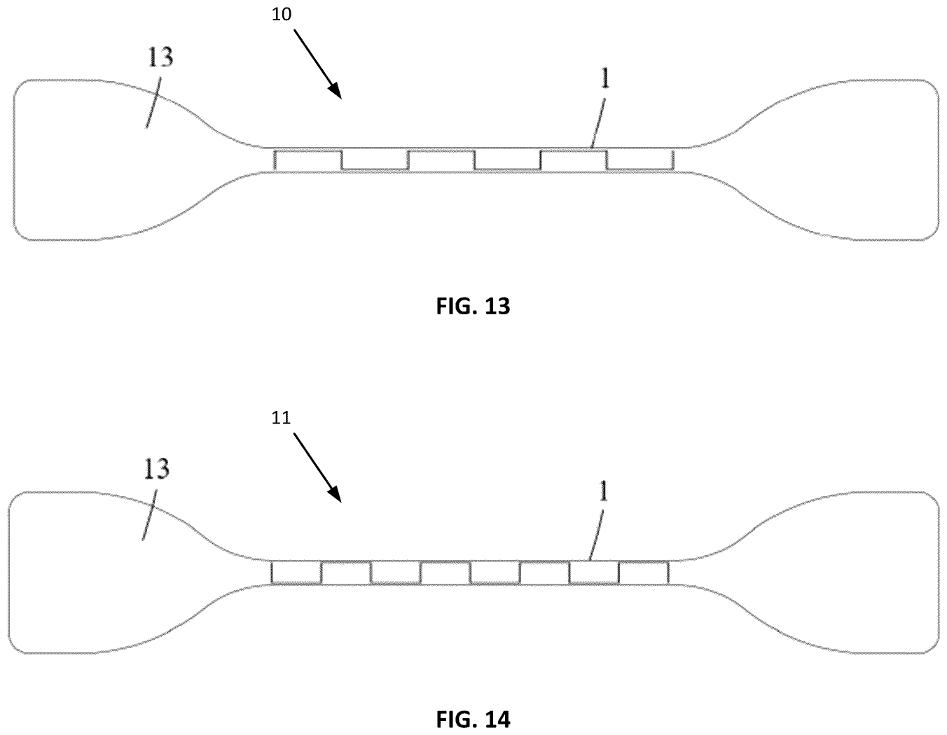

As shown in FIG. 13, unlike Example 8, the horizontal groove is no longer an integral setting, but is connected end to end between adjacent vertical grooves to form a sawtooth structure adjustment groove. Using the same test method and instrument as in Example 2, the resistance value of the fuse body in the No. 10 fuse after processing is measured to be 3.42 mΩ.

The strength and resistance value of the fuse body have been greatly improved. The nanosecond ultraviolet laser can continuously process the sawtooth structure adjustment groove without frequent start and stop, thereby improving processing efficiency.

### Embodiment 12

As shown in FIG. 14, the difference from Embodiment 11 is that the number of vertical slots is increased to ten. Using the same test method and instrument as Embodiment 2, the resistance of the fuse body in the processed No. 11 fuse is measured to be 3.66 mΩ. The resistance of the fuse body increases with the increase of the number of vertical slots. In actual use, the number of vertical slots and the resistance of the corresponding fuse body can be measured and recorded one by one. According to the target resistance value required for actual use, the serrated adjustment slot composed of the corresponding number of vertical slots can be directly processed in the fuse body.

In summary, the fuse structure of the present invention is simple. By precisely processing the fuse body and processing the adjustment hole and/or adjustment slot, the resistance of the fuse is changed, and the design of the fuse is more flexible and free, which provides great convenience for the design and processing of the fuse in the aluminum conductor FPC, meets the demand for low current fusing in the vehicle power management system, and improves the safety of the circuit.

It should be noted that, in this article, relational terms such as first and second, etc. are only used to distinguish one entity or operation from another entity or operation, and do not necessarily require or imply any such actual relationship or order between these entities or operations. Moreover, the terms “include”, “comprise” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, the elements defined by the sentence “include one . . . ” do not exclude the existence of other identical elements in the process, method, article or device including the elements. The above embodiments are only for illustrating the technical concept and features of the present invention, and their purpose is to enable people familiar with this technology to understand the content of the present invention and implement it, and cannot be used to limit the scope of protection of the present invention. Any equivalent changes or modifications made according to the spirit of the present invention should be included in the scope of protection of the present invention.

What is claimed is:

1. A fuse, comprising:
a sheet-shaped fuse body, wherein a width of the sheet-shaped fuse body does not exceed 2 mm, and a thickness of the sheet-shaped fuse body does not exceed 0.2 mm.

2. The fuse of claim 1, wherein the sheet-shaped fuse body is provided with a plurality of adjustment holes and/or adjustment slots.

3. The fuse of claim 1, wherein the sheet-shaped fuse body and a corresponding external circuit are integrally formed.

4. The fuse of claim 1, wherein welding platforms protrude from both ends of the sheet-shaped fuse body, and a width of the welding platforms is greater than a width of the sheet-shaped fuse body.

5. The fuse of claim 4, wherein each of the welding platforms is integrally formed with a sheet-shaped fuse body.

6. A preparation process for a fuse, used to prepare a fuse according to claim 1, characterized in that it comprises the following steps:
S1, contour cutting: cutting aluminum foil into a circuit by optical fiber laser and forming a fuse body at a corresponding position, or cutting the aluminum foil into a fuse body by optical fiber laser;
S2, finishing cutting: using a nanosecond ultraviolet laser to process a width and thickness of the fuse body; and
S3, resistance adjustment processing: using a nanosecond ultraviolet laser to process a number of adjustment holes and/or adjustment grooves in the fuse body.

7. The preparation process for a fuse of claim 6, wherein power of the nanosecond ultraviolet laser is 20 W, frequency is 60 KHZ, wavelength is 355 nm, single pulse energy is 0.33 mj and pulse period is less than 15 ns.

8. The preparation process for a fuse of claim 6, wherein each of the number of adjustment holes is a through-hole structure.

9. The preparation process of the fuse of claim 6, wherein each of the adjustment grooves runs through the fuse body and is arranged along a length and/or width direction of the fuse body.

10. The preparation process of the fuse of claim 9, wherein each of the adjustment grooves is distributed in a sawtooth shape.
